(19) United States
(12) Patent Application Publication
(10) Pub. No.: US 2006/0062182 A1
(43) Pub. Date: Mar. 23, 2006

(54) Method and apparatus for switching channel configurations for a radio bearer

(75) Inventor: Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/230,407

(22) Filed: Sep. 20, 2005

Related U.S. Application Data
(60) Provisional application No. 60/612,081, filed on Sep. 22, 2004.

(51) Int. Cl. H04Q 7/00

(52) U.S. Cl. 370/329

(57) ABSTRACT

A method and apparatus for switching channel configurations for a radio bearer in a wireless communication system is disclosed. The wireless communication system supports one or more different channel types for transporting user data between a wireless transmit/receive unit (WTRU) and a network. The WTRU receives and stores several channel configurations for transport channels (TrCHs) and physical channels in the WTRU. The WTRU maps a radio bearer activating one of the stored channel configurations. Subsequently, the WTRU remaps the radio bearer activating another channel configuration among the stored channel configurations if it is determined that switching a channel configuration is favorable.

### CROSS REFERENCE TO RELATED APPLICATION

This application claims the benefit of U.S. Provisional Application No. 60/612,081 filed Sep. 22, 2004, which is incorporated by reference as if fully set forth.

### FIELD OF INVENTION

The present invention is related to wireless communication systems. More particularly, the present invention is related to a method and apparatus for switching channel configurations for a radio bearer in a wireless communication system.

### BACKGROUND

New technologies are constantly being developed and implemented in wireless communication systems. In order to support the new technologies, the terrestrial network infrastructure needs to be redeployed. However, the redeployment of a network infrastructure is complex and expensive, and cannot be performed ubiquitously across the network at one time. Therefore, it is possible that the new technologies are supported in some places, while they are not supported in other places.

In cellular networks, mobile users frequently move from one cell to another. If the new technologies are supported only in some cells, it is very important that transitions between the new infrastructure and a legacy infrastructure are performed seamlessly and efficiently. Therefore, it is necessary to support services with new methods and legacy methods in one network simultaneously.

In Third Generation Partnership Project (3GPP) standards, multiple radio bearers (RBs) support connections between a wireless transmit/receive unit (WTRU) and a universal terrestrial radio access network (UTRAN) and between the WTRU and a core network (CN).

FIG. 1 represents the establishment of RBs between a WTRU and a UTRAN and between a WTRU and a CN.

Over the air interface, RBs are multiplexed onto transport channels (TrCHs), and TrCHs are multiplexed onto a physical channel. Each TrCH offers a specific quality of service (QoS) for the RBs that are mapped to it. More than one TrCH may be mapped to one physical channel, which is known as a coded composite TrCH (CCTrCH). FIG. 2 shows the mapping and multiplexing of RBs onto TrCHs, and onto a physical channel.

High speed downlink packet access (HSDPA) has been introduced in 3GPP standards. Before HSDPA was added to the standards, dedicated TrCHs and dedicated physical channels were mapped and multiplexed for particular RBs as shown in FIG. 2. With HSDPA, RBs are multiplexed onto MAC-d flows which in turn are multiplexed on a TrCH, which is known as a high speed downlink shared channel (HS-DSCH). Only one HS-DSCH exists per WTRU and is mapped to a high speed physical downlink shared channel (HS-PDSCH). This mapping is shown in FIG. 3.

When a WTRU is configured to support HSDPA, both the RB mapping shown in FIG. 2 and FIG. 3 exist simultaneously. Some RBs are mapped to the dedicated TrCHs and dedicated physical channels; and other RBs are mapped to the MAC-d flows, HS-DSCH, and HS-PDSCH.

It is likely that service providers will eventually provide HSDPA hardware and software upgrades within their UTRANs to provide increased throughput and reduced latency for interactive services. The UTRAN upgrade to support HSDPA, however, is complex and costly. Operators will therefore upgrade their networks slowly, which will require switching between the dedicated channels as shown in FIG. 2 and the HSDPA channels as shown in FIG. 3 as users move between cells.

There is also the possibility that HSDPA channels will not have the range offered by dedicated channels. For Release 99/4 of 3GPP standards, cell sites are deployed by consideration of the range offered by dedicated channels (DCHs). UTRAN redeployment for reduced range HSDPA services will take time and in some cases will not be possible. This will require switching between the use of dedicated channels and the HSDPA channels as shown in FIG. 3 as users' proximity to cell sites changes.

Prior to introduction of HSDPA, interactive services, (e.g., web browsing), were supported by RBs that were mapped to DCHs as shown in FIG. 2. With the introduction of HSDPA, these services are supported by the HSDPA, which requires additional RB mapping as shown in FIG. 3. The RBs that would be mapped to the HS-DSCH have to be removed or added to the dedicated channels as users transit between each configuration. Therefore, in addition to configuration of the HSDPA RB mapping and TrCH and physical channel configuration, each time the user transits the dedicated channel RB mapping, TrCH and physical channel must also be reconfigured.

Signaling requirements for TrCH and physical channel configuration and reconfiguration are extensive. Signaling channels over the air interface have limited capacity that can be over utilized by frequent reconfigurations. This limited capacity of the signaling channels also results in delaying propagation of large reconfiguration messages, which results in delaying establishment of RBs upon each transition. This affects the users' QoS and reduces radio resource capacity.

### SUMMARY

The present invention is related to a method and apparatus for switching channel configurations for an RB in a wireless communication system. The wireless communication system supports one or more different channel types for transporting user data between a WTRU and a network. The WTRU receives and stores several channel configurations for TrCHs and physical channels in the WTRU. The WTRU maps an RB activating one of the stored channel configurations. Subsequently, the WTRU remaps the RB activating another channel configuration among the stored channel configurations if it is determined that switching a channel configuration is favorable.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of the establishment of RBs between a WTRU and a UTRAN and between a WTRU and a CN;

FIG. 2 is a diagram of prior art RB, TrCH, and physical channel multiplexing;

FIG. 3 is a diagram of prior art RB, TrCH, and physical channel multiplexing in HSDPA;

FIG. 4 is a diagram of multiple RB mapping options in a WTRU in accordance with the present invention;

FIG. 5 is a block diagram of a wireless communication system in accordance with the present invention;

FIG. 6 is a flow diagram of a process for switching channel configuration in accordance with the present invention; and

FIG. 7 is an exemplary block diagram of a WTRU for switching channel configurations in accordance with the present invention.

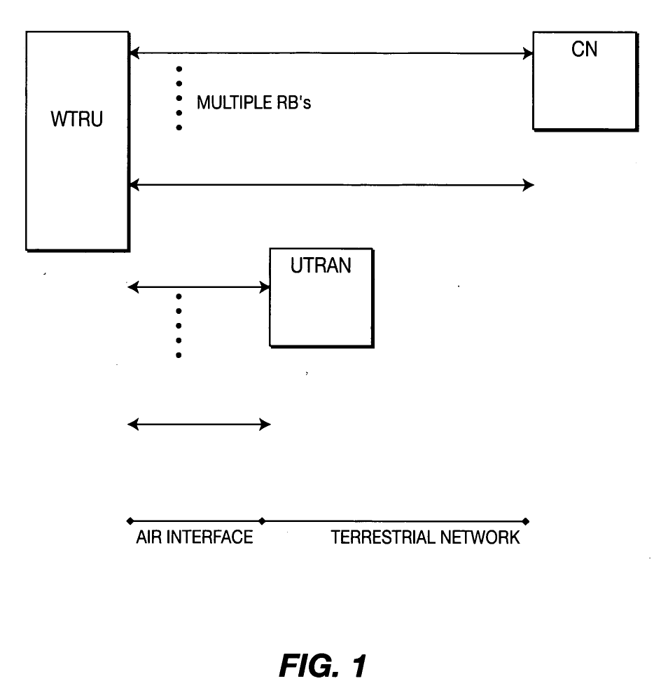

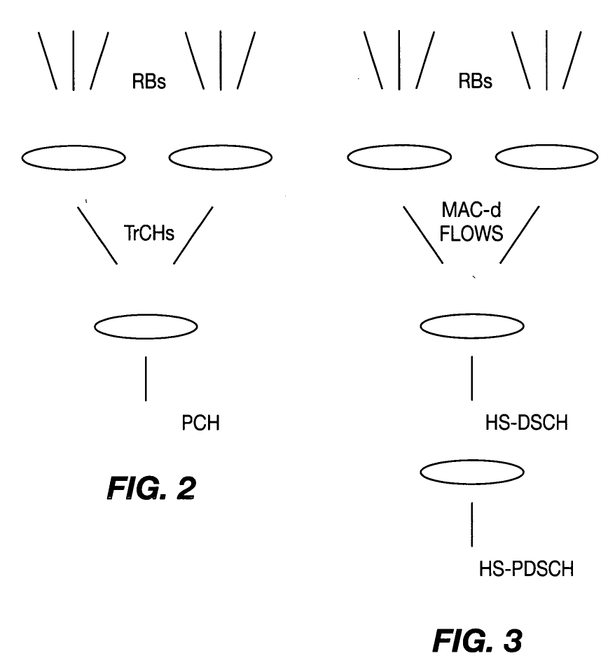

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “base station” includes but is not limited to a Node-B, a site controller, an access point (AP) or any other type of interfacing device in a wireless environment.

The features of the present invention may be incorporated into an integrated circuit (IC) or be configured in a circuit comprising a multitude of interconnecting components.

The present invention provides a method to minimize the signaling requirement for switching channel configurations. Hereinafter, the present invention will be explained with reference to a system supporting two channel types: a dedicated channel (DCH) type and an HSDPA channel type. However, it should be noted that any other type or number of channels, such as high speed uplink packet access (HSUPA) channels, may also be applied without departing from the teachings of the present invention, and the present invention can also be applied to a system with only one type of channel.

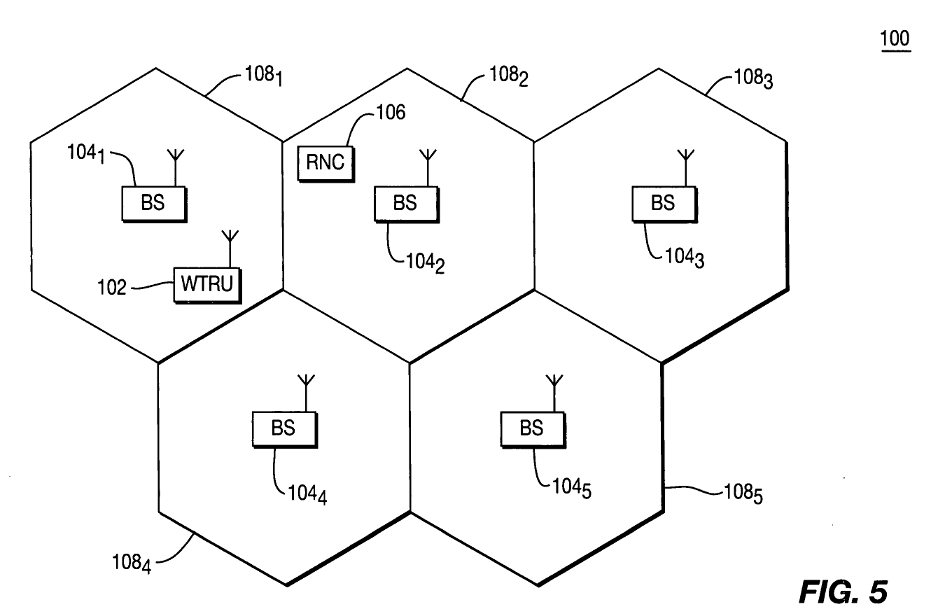

FIG. 5 is a block diagram of a wireless communication system 100 in accordance with the present invention. The system 100 comprises a plurality of cells 108₁₋₅. Each cell 108₁₋₅ is served by a base station 104₁₋₅. The base stations 104₁₋₅ are controlled by a radio network controller (RNC) 106. A WTRU 102 is served by one or more base stations 104₁₋₅ while moving around the cells 108₁₋₅. Only one WTRU 102 and RNC 106 are shown in FIG. 5 for simplicity. However, it should be noted that more than one WTRU 102 and more than one RNC 106 may exist.

In the present invention, a WTRU 102 maintains more than one set of channel configurations. For example, the channel configurations include a transport channel (TrCH) configuration and a physical channel configuration for a DCH type and an HSDPA channel type. The channel configurations are parameter values for TrCH and physical channels in a medium access control (MAC) layer and a physical layer.

In order to switch a channel configuration, an RB mapping is implemented to activate preconfigured alternate TrCHs and physical channels. The TrCHs and physical channels are activated only when RBs are mapped to the channels. Since the WTRU 102 can establish an RB with a new channel configuration utilizing a pre-stored channel configuration, air interface signaling overhead and the RB establishment delay are significantly reduced upon each transition.

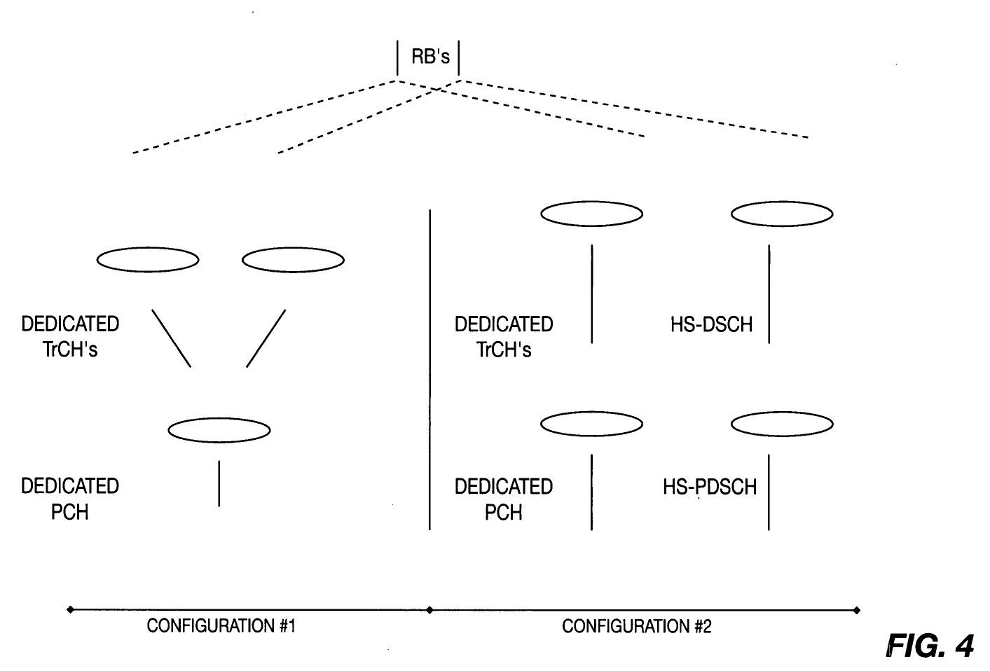

With reference to FIGS. 4 and 5, channel configuration switching in accordance with the present invention is explained. In the system 100 of FIG. 5, only DCHs are supported in cells 108₁₋₃, and both DCHs and HSDPA channels are supported in cells 108₄₋₅. Upon entry into a cell 108₁ in which only DCHs are supported, a first set of configurations for a DCH TrCH and a physical channel, as shown in the left-hand portion of FIG. 4, is signaled to the WTRU 102. The WTRU 102 establishes an RB in accordance with the first set of configurations for the DCHs and receives services with the RB.

As the WTRU 102 moves to another cell, such as cell 108₄, in which both DCHs and HSDPA channels are available, if not previously configured, a second set of DCH and HSDPA channel configurations for TrCHs and physical channels is signaled to the WTRU 102 as shown in the right-hand portion of FIG. 4. The WTRU 102 stores and maintains both the first and the second sets of TrCH and physical channel configurations, even though not all of the configurations are currently applied.

The second set of configurations for the DCH may be same to the first set of configurations for the DCH. In such case, it is necessary that only the RBs suitable for HSDPA are re-mapped to the HS-DSCH. It is possible that one or more of the DCH TrCHs and their corresponding transport format combinations (TFC) within the CCTrCH transport format combination set (TFCS) may be removed from the TFCS.

RB mapping is used to dynamically activate the alternate TrCH and physical channel configurations. Each channel configuration is associated with a unique identification. The specific TrCHs and physical channels that each RB is mapped to are known by this unique identification. TrCHs have identifications that can be expanded to allow for alternate configurations. However, physical channels are provided with identifications unique to their corresponding configurations. There are no identifications for a physical channel in the current 3GPP standards, since only one physical channel of each physical channel type is configured in the WTRU 102. Alternatively, a CCTrCH identification may be used to identify sets of associated TrCHs and the physical channels.

The RB mapping to TrCH and physical channel may be reconfigured each time support for HSDPA is needed to be enabled or disabled. One or more RB mapping options are configured in the WTRU 102, and explicit signaling is used to identify which mapping option is applied. Each time a new RB mapping configuration is applied, the TrCH and physical channel configurations that are newly mapped to the RB are activated in the WTRU 102. The previously applied TrCH and physical channel configurations are maintained in the WTRU 102 unless they are requested to be deleted by explicit signaling.

The active RB mapping may be identified by several means. In one embodiment, the RB mapping is replaced each time the TrCH and physical channel configuration is switched. The RB mapping from logical channels to transport and physical channels is reconfigured by radio resource control (RRC) procedures. This RB remapping reconfiguration procedure may be combined with an RRC handover procedure, which is well known to those of skill in the art.

In another embodiment, more than one RB mapping configuration is stored in the WTRU 102 and a particular RB mapping configuration is chosen and activated through explicit signaling. An RRC procedure identifies which RB mapping configuration is to be activated by the WTRU 102. This RRC procedure for switching RB mapping configurations may be combined with the RRC handover procedure.

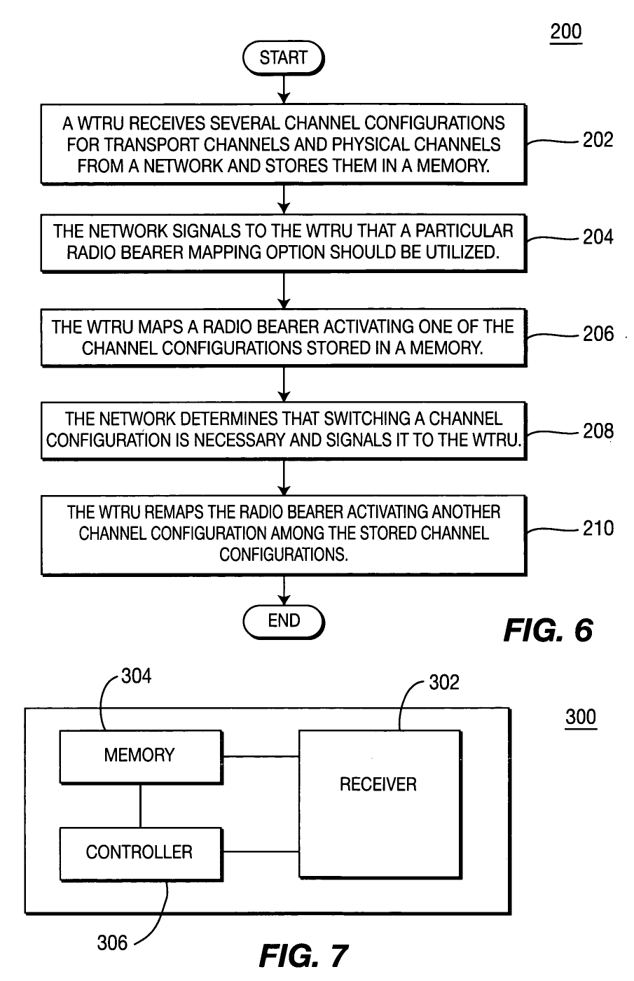

FIG. 6 is a flow diagram of a process 200 for switching channel configurations with the explicit signaling in accordance with the present invention. The WTRU 102 receives the first and second set of configurations for TrCH and physical channels from a network, (e.g., UTRAN), and stores them in a memory in the WTRU 102 (step 202). The network signals to the WTRU 102 that a particular RB mapping option should be utilized (step 204). The WTRU 102 establishes an RB by mapping the RB to a channel configuration stored in the memory, causing the channel configuration to be activated in accordance with the RB mapping option (step 206). Subsequently, the network determines that the current channel configuration used by the WTRU 102 needs to be changed, and sends a request to the WTRU 102 to switch the RB to one of the alternate channel configurations stored in the WTRU 102 (step 208). The WTRU 102 remaps the RB to another channel configuration stored in the memory of the WTRU 102, causing the other channel configuration to be activated (step 210).

FIG. 7 is an exemplary block diagram of a WTRU 300 for switching channel configurations in accordance with the present invention. It should be noted that FIG. 7 shows only the components necessary to explain the present invention and other components which are common to prior art WTRUs are not illustrated. The WTRU 300 comprises a receiver 302, a memory 304 and a controller 306. The receiver 302 receives several channel configurations for at least two different channel types for an RB. The memory 304 stores the received channel configurations. The controller 306 maps the RB to one of the channel configurations stored in the memory 304 which is currently supported, causing the channel configuration to be activated, and remaps the RB to another channel configuration among the channel configurations stored in the memory 304.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including at least one wireless transmit/receive unit (WTRU) and a network, the WTRU including a memory for storing channel configurations, a method for switching channel configurations for a radio bearer (RB) which supports at least one connection between the WTRU and the network, the method comprising:
the WTRU receiving a plurality of channel configurations from the network;
the WTRU for storing the received channel configurations in the memory;
the WTRU mapping an RB to a first one of the stored channel configurations to activate the first channel configuration; and
the WTRU subsequently remapping the RB to a second one of the stored channel configurations to activate the second channel configuration.

2. The method of claim 1 wherein the channel configurations support a dedicated channel (DCH).

3. The method of claim 1 wherein the channel configurations support a high speed downlink packet access (HSDPA) channel.

4. The method of claim 1 wherein the channel configurations support a high speed uplink packet access (HSUPA) channel.

5. The method of claim 1 wherein each of the channel configurations stored in the memory of the WTRU includes at least one transport channel (TrCH) and at least one physical channel.

6. The method of claim 5 wherein a unique identification is assigned to the TrCH and the physical channel of the channel configuration.

7. The method of claim 6 wherein a coded composite transport channel (CCTrCH) identification is used to identify the TrCH and the physical channel.

8. The method of claim 1 wherein the RB is remapped each time support for high speed downlink packet access is required to be enabled.

9. The method of claim 1 wherein the RB is remapped each time support for high speed downlink packet access is required to be disabled.

10. The method of claim 1 wherein the RB is remapped by explicit signaling from the network.

11. The method of claim 10 wherein the explicit signaling is transmitted by a radio network controller (RNC).

12. The method of claim 1 wherein the network is a universal terrestrial radio access network (UTRAN).

13. The method of claim 1 wherein the network is a core network (CN).

14. In a wireless communication system including a network, at least one wireless transmit/receive unit (WTRU) for switching channel configurations for a radio bearer (RB) which supports at least one connection between the WTRU and the network, the WTRU comprising:
a receiver for receiving a plurality of channel configurations from the network;
a memory for storing the received channel configurations; and
a controller for mapping an RB to a first one of the stored channel configurations to activate the first channel configuration, and subsequently remapping the RB to a second one of the stored channel configurations to activate the second channel configuration.

15. The WTRU of claim 14 wherein the channel configurations support a dedicated channel (DCH).

16. The WTRU of claim 14 wherein the channel configurations support a high speed downlink packet access (HSDPA) channel.

17. The WTRU of claim 14 wherein the channel configurations support a high speed uplink packet access (HSUPA) channel.

18. The WTRU of claim 14 wherein each of the channel configurations stored in the memory of the WTRU includes at least one transport channel (TrCH) and at least one physical channel.

19. The WTRU of claim 18 wherein a unique identification is assigned to the TrCH and the physical channel of the channel configuration.

20. The WTRU of claim 19 wherein a coded composite transport channel (CCTrCH) identification is used to identify the TrCH and the physical channel.

21. The WTRU of claim 14 wherein the RB is remapped each time support for high speed downlink packet access is required to be enabled.

22. The WTRU of claim 14 wherein the RB is remapped each time support for high speed downlink packet access is required to be disabled.

23. The WTRU of claim 14 wherein the RB is remapped by explicit signaling from the network.

24. The WTRU of claim 14 wherein the explicit signaling is transmitted by a radio network controller (RNC).

25. The WTRU of claim 14 wherein the network is a universal terrestrial radio access network (UTRAN).

26. The WTRU of claim 14 wherein the network is a core network (CN).

27. In a wireless communication system including a network and at least one wireless transmit/receive unit (WTRU), an integrated circuit (IC) incorporated in the WTRU for switching channel configurations for a radio bearer (RB) which supports at least one connection between the WTRU and the network, the IC comprising:
a receiver for receiving a plurality of channel configurations from the network;
a memory for storing the received channel configurations; and
a controller for mapping an RB to a first one of the stored channel configurations to activate the first channel configuration, and subsequently remapping the RB to a second one of the stored channel configurations to activate the second channel configuration.

28. The IC of claim 27 wherein the channel configurations support a dedicated channel (DCH).

29. The IC of claim 27 wherein the channel configurations support a high speed downlink packet access (HSDPA) channel.

30. The IC of claim 27 wherein the channel configurations support a high speed uplink packet access (HSUPA) channel.

31. The IC of claim 27 wherein each of the channel configurations stored in the memory of the WTRU includes at least one transport channel (TrCH) and at least one physical channel.

32. The IC of claim 31 wherein a unique identification is assigned to the TrCH and the physical channel of the channel configuration.

33. The IC of claim 32 wherein a coded composite transport channel (CCTrCH) identification is used to identify the TrCH and the physical channel.

34. The IC of claim 27 wherein the RB is remapped each time support for high speed downlink packet access is required to be enabled.

35. The IC of claim 27 wherein the RB is remapped each time support for high speed downlink packet access is required to be disabled.

36. The IC of claim 27 wherein the RB is remapped by explicit signaling from the network.

37. The IC of claim 27 wherein the explicit signaling is transmitted by a radio network controller (RNC).

38. The IC of claim 27 wherein the network is a universal terrestrial radio access network (UTRAN).

39. The IC of claim 27 wherein the network is a core network (CN).
